(19) United States
(12) Patent Application Publication
(10) Pub. No.: US 2009/0037261 A1
(43) Pub. Date: Feb. 5, 2009

(54) METHOD AND APPARATUS FOR UTILIZING SEARCH RESULT ADVERTISEMENT INVENTORY

(76) Inventor: Seok Won Cho, San Clemente, CA (US)

Correspondence Address: YAHOO! INC.;C/O DREIER LLP, 499 PARK AVENUE, NEW YORK, NY, 10022, US

(21) Appl. No.: 11/830,101

(22) Filed: Jul. 30, 2007

(51) Int. Cl. G06Q 30/00; G06F 17/30; G06Q 10/00

(52) U.S. Cl. 705/14

(57) ABSTRACT

Optimizing search engine advertising inventory includes storing a plurality of advertisements for a plurality of advertising techniques in an inventory database. The system and method includes, in response to a user search request, selecting one or more advertisements from the inventory database to be displayed in a selected advertising technique based on user click activity, advertisement performance data and the plurality of advertisements, selected for a search results page having the selected advertisement disposed thereon. The system and method thereby determines prospective inventory content for the inventory database based on the selected advertisements and advertising techniques. This prospective inventory content may be used to optimize storage of advertisements and advertising sales techniques, such as giving sales people an indication of which advertising techniques to be marketed or sold.

### RELATED APPLICATION

The present application is related to co-pending patent application Ser. No. ______, entitled “METHOD AND APPARATUS FOR THE PLACEMENT OF ADVERTISEMENTS IN A SEARCH RESULTS PAGE,” filed on ______, 2007.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to advertising techniques relative to computer-based search engine results and more specifically to selecting, for placement on a search results page, one or more advertisements relative to various available advertising techniques from an advertisement inventory.

### BACKGROUND OF THE INVENTION

It is commonplace to use search engines in almost all levels of modem computing. Most widely known techniques are web-based techniques for searching on Internet-based web sites. Equally common with a search request and a search results page, is finding advertisements in various locations on the search results page.

There are many existing and well-known techniques for advertising on web pages. Each of these advertising techniques includes known protocols and algorithms for the placement of the advertisements on the particular search result pages including based on the relevance to search term(s). Although, the problem is that each of these advertising techniques focus solely and exclusively on optimizing each individual technique and fail to include or otherwise take into account the other advertising techniques that may be incorporated on the search results page.

With web-based search advertising, it is not uncommon for an advertiser, the person or entity who pays for the advertisement to purchase or have advertising contracts that include advertisements with more than one advertising technique. Therefore, under existing search engines that place advertising on search result pages, it is possible to cannibalize the advertiser's budget by overlapping advertising techniques. For example, the advertiser might pay for numerous ads placed in different locations on the same search results page, which can be ineffective or the sponsor and the search engine provider trying to maximize revenue per page.

Additionally, existing systems fail to take into account user click activity when selecting advertising techniques. Current technology allows for the tracking of user click activity, but this information is not made available when selecting the placement of advertisements on a search results page. Rather, the system uses standard algorithms that select appropriate advertisements for each of the different advertisement techniques found on the page and then assembles the page with the advertisements for the user.

Additionally, existing systems also fail to recognize the benefits of proper inventory relative to cost-effective or otherwise optimized advertising. Existing systems typically utilize sales people who generate advertising contracts with sponsors who sign up and either pay or are obligated to pay for particular types of advertisements using one or more of the advertising techniques. As described above, since existing systems do not optimize the usage of advertising and advertising techniques, they therein also do not analyze or otherwise account for inventory of advertisements based on this knowledge. Additionally, financial and business benefits are being lost by this knowledge not being known by sales people prior to or while they are either selling or attempting to sell advertising to potential sponsors.

As such, there exists a need for a technique to generate search results that optimizes a selection of an advertisement technique when selecting advertisements for a search results page and also takes into account user click activity in the selection or placement process. Moreover, there exists a need for this benefit to be utilized in optimizing advertising inventories.

### SUMMARY OF THE INVENTION

Generally, the present invention provides for optimizing electronic search engine inventory content. In response to a search request, the search engine determines different advertisements that may be included with the search results to be displayed on the search results page. The ads include different specific advertisements, for example for different sponsors, and also includes different advertisement techniques, such as for the same or different sponsors. As used herein, advertisement techniques refer to the type of advertisement and the underlying model for the advertising activity, such as how the sponsor pays for the advertising for example on a per-click basis, per-view basis, etc. Examples of advertising techniques may include, but are not specifically limited to the following techniques: the cost per click sponsored search (CPC), cost per media product (CPM), cost per period product (CPP) and cost per acquisition product (CPA). An inventory database stores the advertisements.

The system thereupon selects one or more of the advertisements for the different advertising techniques for inclusion with the search results page from the ad inventory database. The selected advertisements may be from different advertising techniques suitable for the search results page. Additionally, the selection of the advertisements may be based on user click activity, advertisement performance data and the plurality of advertisements, where the advertisements are associated with the different techniques. For example, advertisements by a particular sponsor may be determined as being appropriate for the search results page, but the present invention may select an advertisement from a first technique over a second technique to optimize the effectiveness of the advertisement. In the same example, sponsor advertisements may be selected for a particular advertising technique instead of being included in numerous advertising techniques on the same search results page, to maximize the advertisement exposure.

Thereupon, the present invention includes the generation of the search result page having the selected advertisements thereon. These advertisements may be embedded or included based on the corresponding advertising technique, such as being in a conspicuous location on the search results page, included in the search result listings, or other techniques, by way of example. The advertisements included in the search results page are thereby optimized for the benefit of the sponsor and the search engine provider.

The present invention therein includes determining prospective inventory content for the inventory database based on the selected advertisements and advertisement techniques. From this determination, the system may then seek to optimize the inventory, such as allowing sales people to sell different types of advertisements and advertising techniques that are determined to be the most effective for the underlying search results page.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of an apparatus for optimizing electronic search engine inventory content;

FIG. 2 illustrates a computing system utilizing the optimization of electronic search engine inventory content;

FIG. 3 illustrates a block diagram of one embodiment of elements for optimizing advertising revenue usable in optimizing inventory content;

FIG. 4 illustrates a sample screen shot including numerous advertising techniques; and

FIG. 5 illustrates a flowchart of the steps of one embodiment of a method for optimizing electronic search engine inventory content.

### DETAILED DESCRIPTION OF THE INVENTION

In the following description of the embodiments of the invention, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

FIG. 1 illustrates an advertisement inventory optimization device 100 providing for the optimization of advertising on a search results page and the corresponding inventory for an advertising database by determining the optimized placement of advertisements using proper advertisement techniques and determination of advertisements and advertisement techniques for storage in the database. The device 100 is illustrated generally in nature, but as described in further detail below, may be operational within a larger search engine processing system or device.

The device 100 includes a processing device 102, memory device 104 and three databases: an advertisement inventory database 106, a performance database 108 and a user activity database 110. The processing device 102 may be any suitable type of device capable of electronically performing computational operations in response to executable instructions, where the processing device 102 may include one or more processing device or elements in a centralized or distributed processing manner. The memory device 104 and databases 106, 108 and 110 may be any suitable type of data storage device, including one or more storage devices in a centralized or distributed storage manner. The memory device 104 includes executable instructions 112 stored therein readable by the processing device 102 for performing operations, as described in further detailed herein.

The advertisement inventory database 106 includes information on the inventory of advertisements. In one embodiment, the advertisement information may include text or figures to be included in the advertisement. The advertisement inventory information may also indicate the advertising sponsor, the associated advertising technique and costs associated with the particular advertisement itself and/or the advertising technique. Additionally, the database 106 may include information associating advertisements and/or techniques with one or more particular search terms.

The performance database 108 includes performance data relating to the performance or effectiveness of an advertising technique and/or advertisement itself. The performance data stored in the database 108 may indicate that one technique generates more revenue compared with others, for example, or in another example may be more relevant but not generating as much revenue.

The user activity database 110 includes data for user click activity. This user click activity data may be specific to a registered user, such as registered through a cookie or other type of identification instrument. This data may be acquired through tracking the user selection activity using any number of suitable known user activity tracking and selection techniques. Additionally, this data may be more generalized and not directed to a specific user, such as general user click activity tracked over a large sample of users.

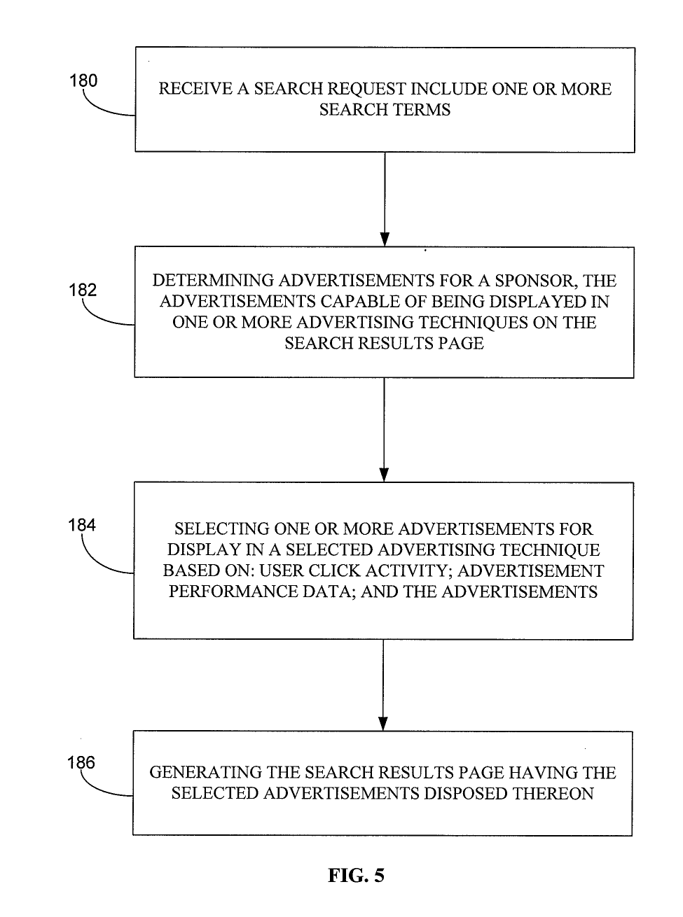

The processing device 102, using techniques as described in further detail below, is operative to utilize the advertisement inventory data, the associated performance data and the user click data to define the optimal selection and display of advertisements to minimize revenue cannibalization between different advertisements in advertisement techniques and maximize overall page revenue. Using this optimal selection, the processing device 102, in response to the executable instructions 112, is further operative to optimize the inventory of the advertising database 106, such as described in further detail below, including but not limited the methodology of the steps of the flowchart of FIG. 5.

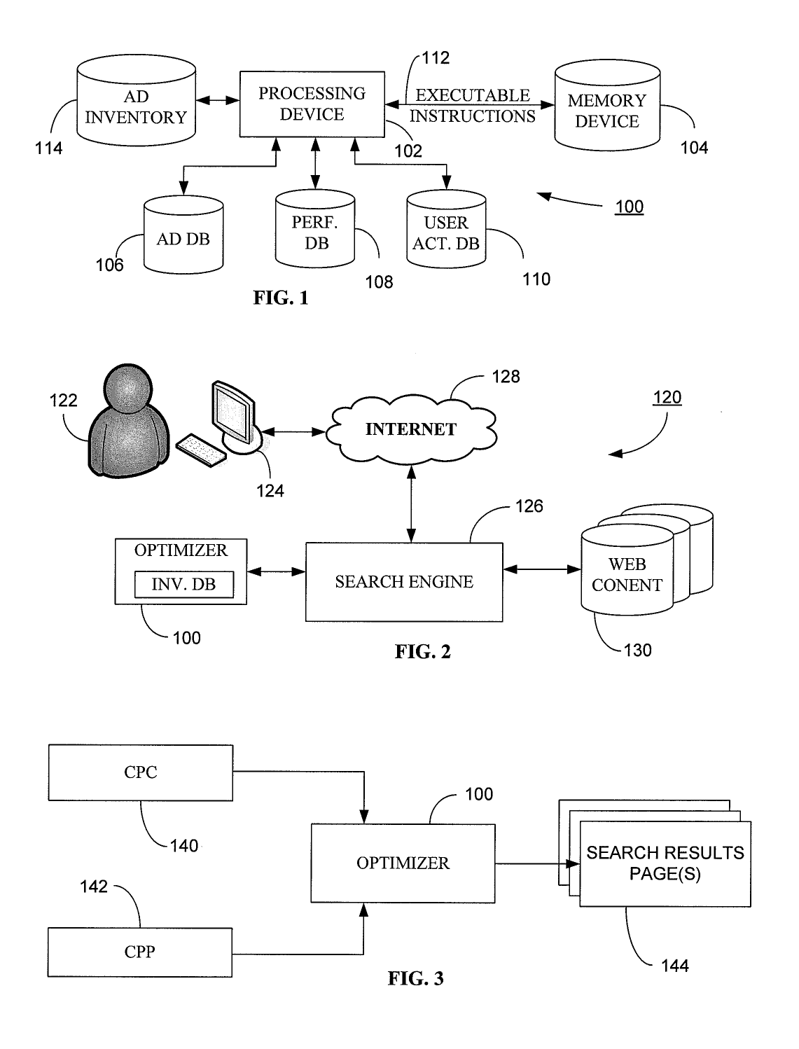

FIG. 2 illustrates a system 120 using the device 100 of FIG. 1, herein referred to as the optimizer 100. In the system 102, a user 122, using a computing device 124, accesses a search engine 126 through the Internet 128. The search engine 126 is in communication with web content databases 130 and the optimizer 100.

The search engine 126 may be any suitable type of search engine, such as a search engine portal referenced by the user 122 through a URL. The search engine 126 may encompass one or more processing devices capable of receiving search requests having search terms and accessing the web content databases 130 that provide hyperlinks or other types of search results. In accordance with known search engine technology, the search engine 126 not only performs the search, but also is operative to generate a search results page. Although, the search engine 126 further includes optimized advertising in the search results page via the optimizer 100.

It is recognized that additional known features and elements have been omitted, for clarity purposes only, between the computing device 124 and the search engine 126, such as communication and routing elements for interacting across the Internet 128. It is also recognized that the network 128, while illustrated as the Internet, may be any suitable type of network, such as an internal, local or private network, by way of example.

In one embodiment, the user 122 sends a search request to the search engine 126. The search engine 126 may perform known content searching operations by accessing the web content databases 130. Although, in generating a search results page, the search engine 126 also accesses the optimizer 100.

In one embodiment, the optimizer 100 uses a page module, where the page refers to the search results page provided to the user 122. A page module is defined as distinct groups of listing for content for a given keyword, where the content may be paid content or algorithmic content.

Each page module includes three (3) properties, a revenue per search module (mRPS), a relevance index module (mRI) and a confidence index (mCI). The revenue per search (mRPS) module is set to zero for non-monetization products. The relevance index module (mRI) is equal to a click through rate module (mCTR). The confidence index (mCI) module is equal to a distribution of a historical module fingerprint (mFP) and a current module finger print, (d[historical mFP, current mFP]).

The modules may also be different based on the advertising techniques, such as the exemplary techniques of: CPC, CPM, CPP, and/or CPA.

In one embodiment, the module revenue per search may be defined by Equation 1 for CPC products and by Equation 2 for non-CPC products, such as CPM and CPP advertising techniques.

mRPS=mCTR*mCOV*mCPC EQUATION 1:

mRPS=mCOV*CPS*mDEPTH EQUATION 2:

The mCTR factor is the module click through rate, whereby in one embodiment historical performance can be used as a future performance indicator or estimator. For example, different indexed periods may be used, wherein the shorter the interval, the more accuracy can be obtained in the optimization calculations.

The mCOV value refers to a Coverage module, which is a known value currently available from existing systems, which is either a “0” or a “1” value. The module cost per click (mCPC) is an existing value that can be obtained from the existing search inventory system, wherein the cost per click may be set equivalent to the cost per click of a first or prior result. The CPS value refers to a cost per search amount.

The fingerprint module (mFP) includes an indexed historical fingerprint for each keyword and if the fingerprint changes, the system discounts accordingly in a linear fashion based on the current module fingerprint distance from the click through rate module.

In one embodiment, the above-noted modules utilize values that can be calculated in an offline fashion for indexing and storing historical performance indices. The module values themselves may then be computing at run-time.

The optimizer 100 may thereupon optimize ad revenue by adjusting revenue and relevance values, or dials. These adjustable values relate to revenue and relevance for advertisements. In one embodiment, the values are adjusted between a minimum value, e.g. zero, and a maximum value, e.g. one, where the maximum value indicates the highest revenue and/or relevance. The mRPS and MRI values have their own relative marketplace bounded by the modules that have such property on the search results page. In one embodiment, the mRPS and mRI do not directly or inversely correlate in a linear fashion and can be linearly independent.

In one embodiment, the optimizer 100 may take a conservative approach and denote modules that have a greater fingerprint distance from historical indexed values. In essence, for each module on the search results page, the system may calculate a score using a rank score module (mRS), as defined by Equation 3.

mRS=mCI((mRPS*PREVENUE)+(mRI*pRELEVANCE)) EQUATION 3:

where the pREVENUE and pRELEVANCE values may be adjusted between the minimum values and the maximum values.

The optimizer 100 thereupon ranks the modules based on the relative mRS values for each module. This information may then be used to determine which advertisements are selected and their corresponding advertising techniques. The selected advertisements are then presented to the search engine 126 for inclusion and rendering in the search results page to the user 122.

The optimizer 100 optimizes the revenue of the advertisements while maintaining the proper relevance. The system 100 may be akin to a balance, whereby the system must balance the ad revenue with the search result relevance. These elements do bare a larger relationship as irrelevant advertising techniques or advertising content can directly influence revenue. But as described above, to optimize revenue and prevent against cannibalizing revenue availability between different advertising techniques, the optimization may take into account competing advertisements in competing or complimentary advertisement techniques on the search results page. Stated another way, revenue may be optimized by placing one sponsor's advertisements at all locations on a search results page, but this diminishes relevance because the sponsor is paying for a significant percentage of ads that may not be viewed or selected. Thereby, to optimize revenue for the search results page as well as the relevance of the advertisement, one or more particular advertisements and corresponding advertisement techniques are appropriately selected.

FIG. 3 is a sample illustration of one embodiment of the application of the method for optimized advertising revenue. The system illustrates two sample advertising techniques that have associated advertisements. The first technique is the cost per click sponsored search 140 and the second is a cost per period product 142. These two sample advertising techniques and corresponding advertisements have different relevance and revenue factors based on the associated search results.

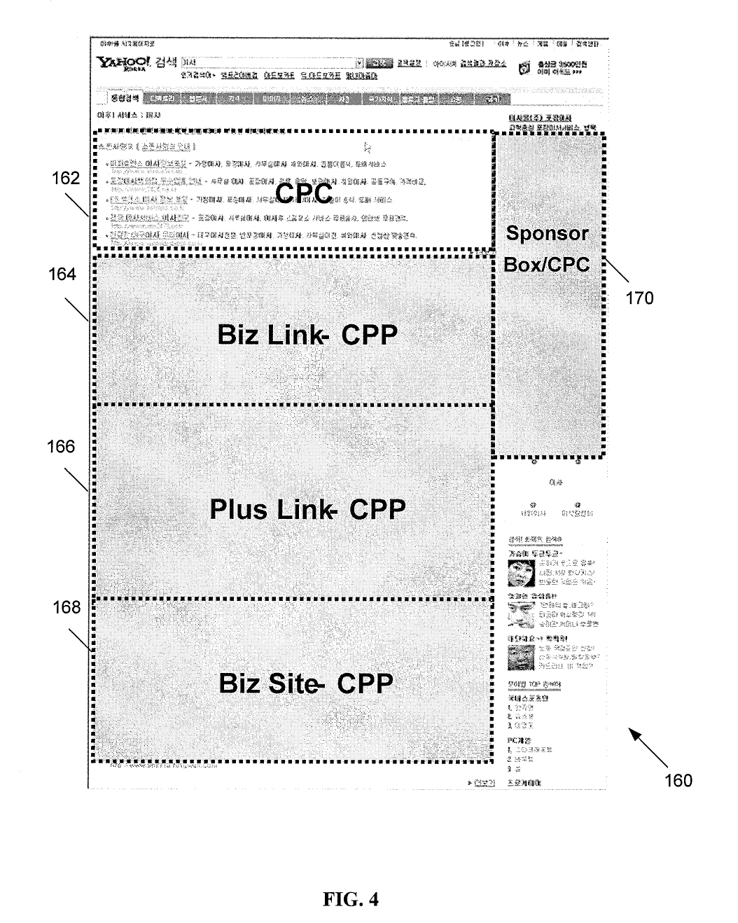

In response to a search request and search results, the ad revenue optimizer 100 receives, or in another embodiment retrieves, advertisements from the different advertising techniques. In a typical embodiment, the advertising techniques may be associated with a predefined section or area of a search results page, as discussed in further detail below regarding FIG. 4. The optimizer 100 thereupon provides the selected advertisements for insertion or inclusion into the search results page(s) 144 associated with the particular search result techniques. As described below, the optimizer 100 may thereupon use the recognition of the advertisements and advertisement types for the optimization of the storage or inventory of advertisements in the search engine or search processing system.

FIG. 4 illustrates a sample screen shot 160 of a search results page with separate advertising techniques thereon. This exemplary search result page includes a CPC section 162, a business link CPP section 164, a plus link CPP section 166, a business site CPP 168 section and a sponsor box/CPC section 170. This sample screen shot illustrates how many numerous advertising techniques may be simultaneously displayed. The sample screen shot, as generated in accordance with the method and apparatus described herein, includes the optimized selected advertisements for each of the different sections in this search results page.

FIG. 5 illustrates a flowchart of one embodiment of a method for optimizing electronic search engine inventory content. As described above, the inventory optimization works in association with the optimization of which advertisements in different advertising techniques are to be placed on the search results page.

A first step, step 180, is storing, in the inventory database, any number of advertisements for different advertising techniques. As described above, these may include generalized advertising content capable of being converted into different techniques or can include technique-specific advertisements.

A next step, step 182, is, in response to a user request, selecting one or more advertisements to be displayed in a selected advertising technique. As described above, the selection is based on at least three factors including: (1) the user click activity; (2) advertisement performance; and (3) the inventory of available advertisements. The selected advertisements and the corresponding techniques are added to the search results page.

A next step, step 184, is to determine prospective inventory content for the inventory database based on the selected advertisements and advertisement techniques. This determination may include noting that one particular advertisement and/or advertising technique has a greater selection rate compared with another advertisement and/or advertising technique. As described above, the optimizer of FIGS. 1 and 2 optimizes to balance the conflicts between relevance and revenue, therefore this balance can be further harnessed through the determination of step 184 by recognizing which advertisements and/or techniques are selected, how often and when. This step may include taking an inventory of existing advertisements and associated techniques relative to the supply and demand of the determined or estimated by the advertisement inventory. For example, it may be estimated that a certain number of searches and advertisements may be needed for a period of time. When determining prospective inventory, the existing inventory can be used as a baseline amount.

The next step, in this embodiment, is step 186, whereby the inventory content is optimized based on the prospective inventory. The prospective inventory may be the ideal number of advertisements for different techniques in response to determined supply and demand in step 184. The optimization of the inventory may include passing this information along to sales people who may then attempt to secure advertisement revenue from sponsors in specific advertising techniques. For example, it could be determined that for a particular range of search terms, a CPC advertising technique is more effective, therefore sales people could attempt to sell more of these ads instead of a lesser cost effective technique.

Thereby, the above-described device and its operations performance in response to executable instructions provides for optimizing the inventory of advertisements used with the selection and placement of the advertisements in a search results page, where the selection is conducted to prevent cannibalization between advertisement techniques and maximize overall advertisement page revenue.

FIGS. 1-5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms memory and/or storage device may be used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for optimizing electronic search engine advertisement inventory content, the method comprising:
storing, in an inventory database, a plurality of advertisements for a plurality of advertising techniques;
in response to a user search request, selecting at least one of the plurality of advertisements to be displayed in a selected advertising technique based on user click activity, advertisement performance data and the plurality of advertisements, selected for a search results page having the selected advertisement disposed thereon; and
determining prospective inventory content for the inventory database based on the selected advertisements and advertising techniques.

2. The method of claim 1 further comprising:
generating sales recommendations for prospective sponsors and advertisements based on the determined inventory content.

3. The method of claim 2 further comprising:
determining existing inventory content, including existing advertisement inventory and advertising techniques such that the sales recommendations take into account the existing inventory content.

4. The method of claim 1, wherein the advertising techniques include a cost per click technique, a cost per media technique, a cost per period technique and a cost per acquisition technique.

5. The method of claim 4, wherein the advertising techniques include associated ad revenue models such that the selection of the at least one of the plurality of advertisements is based on the ad revenue models of the advertising techniques associated with the plurality of advertisements.

6. The method of claim 1 further comprising:
in response to the search request including a search term, retrieving search result from at least one search database; and
selecting the plurality of advertisements from the inventory database based on the search term.

7. The method of claim 1, wherein the search results page includes the selected advertisements disposed at different advertising locations on the search results page, in accordance with corresponding advertising techniques.

8. Computer readable media comprising program code that when executed by a programmable processor causes the processor to execute a method for optimizing electronic search engine advertisement inventory content, the computer readable media comprising:
program code for storing, in an inventory database, a plurality of advertisements for a plurality of advertising techniques;
in response to a user search request, program code for selecting at least one of the plurality of advertisements to be displayed in a selected advertising technique based on user click activity, advertisement performance data and the plurality of advertisements, selected for a search results page having the selected advertisement disposed thereon; and
program code for determining prospective inventory content for the inventory database based on the selected advertisements and advertising techniques.

9. The computer readable media of claim 8 further comprising:
program code for generating sales recommendations for prospective sponsors and advertisements based on the determined inventory content.

10. The computer readable media of claim 9 further comprising:
program code for determining existing inventory content, including existing advertisement inventory and advertising techniques such that the sales recommendations take into account the existing inventory content.

11. The compute readable media of claim 8, wherein the program code for advertising techniques includes a cost per click technique, a cost per media technique, a cost per period technique and a cost per acquisition technique.

12. The computer readable media of claim 11, wherein the program code for advertising techniques includes associated ad revenue models such that the selection of the at least one of the plurality of advertisements is based on the ad revenue models of the advertising techniques associated with the plurality of advertisements.

13. The computer readable media of claim 8 further comprising:
in response to the search request including a search term, program code for retrieving search result from at least one search database; and
program code for selecting the plurality of advertisements from the inventory database based on the search term.

14. The computer readable media of claim 8, wherein the program code for generating the search results page includes the selected advertisements disposed at different advertising locations on the search results page, in accordance with corresponding advertising techniques.

15. A apparatus for optimizing electronic search engine advertisement inventory content, the apparatus comprising:
an inventory database;
a memory device having executable instructions stored therein; and
a processing device, in response to the executable instructions, operative to:
store a plurality of advertisements for a plurality of advertising techniques in the inventory database;
in response to a user search request, select at least one of the plurality of advertisements to be displayed in a selected advertising technique based on user click activity, advertisement performance data and the plurality of advertisements, selected for a search results page having the selected advertisement disposed thereon; and
determine prospective inventory content for the inventory database based on the selected advertisements and advertising techniques.

16. The apparatus of claim 15, the processing device, in response to the executable instructions, further operative to:
generate sales recommendations for prospective sponsors and advertisements based on the determined inventory content.

17. The apparatus of claim 15, the processing device, in response to the executable instructions, further operative to:
determine existing inventory content, including existing advertisement inventory and advertising techniques such that the sales recommendations take into account the existing inventory content.

18. The apparatus of claim 15, wherein the advertising techniques include a cost per click technique, a cost per media technique, a cost per period technique and a cost per acquisition technique and wherein the advertising techniques include associated ad revenue models such that the selection of the at least one of the plurality of advertisements is based on the ad revenue models of the advertising techniques associated with the plurality of advertisements.

19. The apparatus of claim 15, the processing device, in response to the executable instructions, further operative to:
in response to the search request include a search term, retrieving search result from at least one search database; and
select the plurality of advertisements from the inventory database based on the search term.

20. The apparatus of claim 15, wherein the search results page includes the selected advertisements disposed at different advertising locations on the search results page, in accordance with corresponding advertising techniques.
